(19) United States
(12) Patent Application Publication
(10) Pub. No.: US 2006/0166002 A1
(43) Pub. Date: Jul. 27, 2006

(54) Decorative composite material and functional elements constructed therefrom

(76) Inventors: Dyan Grey, New York, NY (US); Robert Bacarella, Hauppauge, NY (US)

Correspondence Address: GORDON & JACOBSON, P.C., 60 LONG RIDGE ROAD, SUITE 407, STAMFORD, CT, 06902, US

(21) Appl. No.: 10/534,384

(22) PCT Filed: Nov. 5, 2003
(86) PCT No.: PCT/US03/35187

§ 371 Date: May 4, 2005

(30) Foreign Application Priority Data
Nov. 8, 2002 (US) 604249077

(51) Int. Cl. B32B 27/38; B32B 33/00; C08L 63/00

(52) U.S. Cl. 428/413; 428/42.1; 523/400

(57) ABSTRACT

Decorative composite materials in the form of tiles, trays, light boxes, furniture, surfaces, partition walls, dividing screen doors, and the like include a combination of elements embedded and/or encapsulated in a highly durable epoxy resin mixture that allows the embedded and or encapsulated elements to appear as if they are suspended or floating in space.

### BACKGROUND OF THE INVENTION

1. Field of the Invention

The invention relates to decorative composite materials that may be used in flooring, surface ornamentation, and other decorative applications.

2. State of the Art

There are several existing types of surface decoration materials. These include resilient materials, wood, tiles, stone, and concrete. Each of these materials has its unique advantages, but all suffer from significant disadvantages, such that none represents an ideal surface decoration material.

Resilient materials include vinyl tiles and sheets based on polyvinylchloride (PVC) chemistries; vinyl composition (e.g., asphalt) tiles and sheets that includes various fillers that decrease the amount of polyvinylchloride used; rubber tiles and sheets made from synthetic rubber; cork tiles made from granulated pieces of bark from the cork oak tree bonded together in combination with a binder/adhesive using heat and pressure; vinyl-faced cork tiles made from cork and thermoplastic binders and laminated with a layer of polyvinylchloride; and linoleum tiles and sheets, which are a composition of oxidized linseed oil (or other binders), pigments, and fillers which are applied over a backing.

These resilient materials may be manufactured in a wide variety of colors and patterns, are easy to install, and are relatively economical. However, a major drawback is that, when used as flooring materials, they do not wear well, particularly in high-traffic areas. Further, they are easily susceptible to damage from scuffs, indentation from high-heeled shoes or hard objects dropped on the flooring, or staining, due to its porosity. Cork flooring is particularly susceptible to such types of damage. In addition, regular maintenance of the flooring is required. In addition to washing, most resilient flooring needs to be waxed and polished in order to maintain its attractiveness and periodic stripping of built-up wax is necessary.

In particular, vinyl flooring exhibits varying resistant to stains and bums, and varying resilience. Vinyl composition flooring exhibits low resistance to burns and abrasion, low resilience and flexibility, and can be noisy. In particular, asphalt tiles exhibit a low resistance to alkalis, bums, grease, and oil, in addition to having low resilience and flexibility, and noisiness. Rubber flooring exhibits low resistance to greases and oils. Cork flooring has low resistance to alkalis and stains, low resistance to moisture, easily fades, and does not well bear heavy loads or concentrated foot traffic. Linoleum exhibits low resistance to indentations, bums, and alkalis, and tends to be noisy.

Wood is another widely used decorative surface material. Typically, oak, maple, beech, birch, bamboo, and other decorative woods are used for this purpose. Wood flooring can be laid in thin strips, typically in 1½ inch to 2¼ inch widths, with varying lengths and joined by tongue and groove or beveled edges; planks, typically in 3¼ inch to 8 inch widths, again with varying lengths and joined by tongue and groove or beveled edges; pre-assembled blocks, which may comprise unit blocks held together with wood or steel splines, laminated block requiring 3 to 5 plies of cross-laminated wood veneer, parquet, which is pre-assembled in sections of several thin, small slats of wood creating patterns; or solid block flooring, made of solid (wood) end-grain blocks ranging from 2 inches to 4 inches in thickness.

Wood flooring may also be manufactured in a wide variety of colors and patterns. However, it is more diff cult and expensive to install and maintain. Although it wears better than resilient flooring, particularly in high-traffic areas, it too is susceptible to damage from scuffs, indentation from high-heeled shoes or hard objects dropped on the flooring, or staining, due to its porosity. Unlike resilient flooring, wood flooring is a natural material that expands and contracts with changes in temperature and humidity. If not installed properly, wood flooring can buckle (tenting). Tenting can also occur as the result of water damage. In addition, wood flooring can crack due to dryness. Regular maintenance of wood flooring is also required, including washing, waxing and polishing in order to maintain its attractiveness and periodic stripping of built-up wax. While use of a polyurethane coating reduces the damage caused by wear and otherwise, and reduces the need for waxing, this coating must also periodically be stripped and reapplied, which process is more involved and more expensive than with waxed floors.

Tile is also a relatively versatile decorative material. There are several different types of lo tile, including impervious, non-vitreous, semi-vitreous, and vitreous. Tiles can be ceramic, made from wet-formed clay, clay mixture, or other ceramic materials and then fired to the desired hardness; quarry tiles, made from natural clay or shale and formed by extrusion; or paver tiles, made from relatively dry clay shaped into tiles with dust pressed method.

Although tiles exhibit perhaps the widest variation in possible decorative effect, they significantly reflect sound and tend to be cold. Also, the tile glazing can crack allowing dirt to collect in cracks and discolor, and ceramic tiles are highly susceptible to breakage, water damage due to moisture. Finally, the grouting constantly gets dirty and cracks, requiring cleaning and periodic re-grouting. In addition, when used as flooring, ceramic tile tends to wear, losing their pattern, and heavy traffic can cause uneven wear and cupping. Quarry tiles also exhibit pattern wearing and have the same grouting problems as ceramic tiles. Paver tiles also tend to wear, resulting in the loss of their decorative pattern.

Another common surfaced decoration material is stone. A variety of stone materials are typically used, including granite, which is an igneous rock with embedded grains; limestone, including travertine, which has holes that are filled with resin when used as a flooring material; marble, which is a metamorphic rock formed from layers of shells, under heat coupled with pressure, into a composition consisting of crystalline grains of calcite and dolomite; sandstone, which is a sedimentary rock containing sand with other substances; and slate, which is a metamorphic rock with fine grains that tends to easily form flat sheets.

Although imparting significant natural beauty, stone can be the most expensive surface decoration material. In addition, it is cold to the touch, greatly reflects sound, can crack, and the grout used to install it gets dirty and cracks, requiring regular maintenance. Further, because it is a natural material, stone is available in different grades. Some stone has flaws, voids, and veins which need repair and which lessen the decorative effect. Perhaps most lo significantly, it is very difficult to obtain stone that exactly meets the decorative requirements of the designer and nearly impossible to match any replacement stone that may be required years after the installation, even if obtained from the original quarry.

Other materials used for surface decoration include concrete, bricks made of concrete or clay, and leather tiles made from tanned hides of animals, primarily cattle and swine. Concrete, although economical and easy to shape, holds moisture for several weeks after installation, tends to crack, is cold to the touch, often makes the room seem damp, and has limited decorative effect. Bricks tend to wear when used as a flooring material; are very difficult to obtain a flat, easily maintained surface; and are installed using mortar, which is more difficult and expensive to maintain than tile grout. Leather tiles tend to crack if not regularly oiled, easily stain, and can 20 curl at the edges due to adhesive failure in response to changes in temperature and humidity.

Even resin tiles have been used. For example, Jap. Pub. No. 62271713A teaches a resin tile encasing a decorative metallic film. However, known resins vary widely in their stability and suitability for many surfaces.

What is needed are decorative materials that are highly resistant to wear and damage; consistently look clean; are relatively easy and economical to manufacture, install, and maintain; are attractive and provide a wide variety of decorative effects; and that appeal to a broad audience.

### SUMMARY OF THE INVENTION

It is therefore an object of the present invention to provide decorative materials that are highly resistant to wear and damage.

It is another object of the present invention to provide decorative materials that are relatively easy and economical to manufacture, install, and maintain.

It is an additional object of the present invention to provide decorative materials that are attractive and provide a wide variety of decorative effects.

The present invention comprises decorative composite materials in the form of tiles, trays, light boxes, furniture, surfaces, partition walls, dividing screens, doors, and the like. These materials comprise a combination of elements embedded and/or encapsulated in an epoxy resin mixture that preferably allows the embedded and/or encapsulated elements to appear as if they are suspended or floating in space.

The materials provide superior flexibility of design element selection. They are easily installed using adhesives and can easily be cleaned with either a dry or damp mop or cloth, preferably with a biodegradable cleaner. Items, particularly tiles and other planar items, made from the materials may easily be refaced and refinished by lightly sanding and filling with epoxy.

Items made with the materials of the present invention may be highly decorative, are extremely durable, and may easily be made according to custom specifications. In addition, the finished tiles are solvent-free. They are waterproof, experience no shrinkage, contraction, or expansion; and are highly resistant to physical or chemical degradation. Specifically, they are resistant to mild mineral acids, alkalis, detergents, solvents, skydrol, hydraulic fluids, lubricating oils, salts, and the like.

Different design possibilities contemplated include tiles with encapsulated netting, photographs or other image media, and or combinations thereof, embedded or encapsulated gravel, sand, mica flakes, wood chips, fibers, textiles, and other natural and or manufactured items or materials. These elements may be arranged in any desired fashion, including random dispersal, stripes, swirls, geometric patterns, and the like.

Items contemplated by the present invention include dividing screens; room partitions; partition walls (with or without wheels or other means for movement); doors; indoor and outdoor furniture, including tables, tabletops, desks, chairs, chair backs; surfaces, including countertops, shelves, steps, walls and the like; light boxes; trays; and other such decorative structural and functional items.

Additional objects and advantages of the invention will become apparent to those skilled in the art upon reference to the detailed description taken in conjunction with the provided figures.

### BRIEF DESCRIPTION OF THE DRAWINGS

FIG. 1A-C show a perspective view of the three steps of manufacture of an embodiment of a decorative tile according to the invention.

FIGS. 2A-C show a perspective view of the three steps of manufacture of a second embodiment of a decorative tile according to the invention.

FIGS. 3A-C show a perspective view of the steps of manufacture of a third embodiment of a decorative tile according to the invention.

FIGS. 4A-C show a perspective view of the steps of manufacture of a fourth embodiment of a decorative tile according to the invention.

FIGS. 5A-C show a perspective view of the steps of manufacture of a fifth embodiment of a decorative tile according to the invention.

FIGS. 6A-C show a perspective view of the steps of manufacture of an embodiment of a decorative tile according to the invention.

### DETAILED DESCRIPTION OF EMBODIMENTS

Decorative objects of the present invention are preferably made from a two-stage material comprising a base portion and a reactor (hardener) portion, which form a curable resin. Table 1 sets forth a preferred two-stage material for the resin.

TABLE 1

| | | Preferred | Most |
|---|---|---|---|
| | | Weight % | Preferred |
| | CAS# | Range | Weight % |
| Base Portion | | | |
| Polymer of | 020585-99-8 | 75-93 | 82 |
| Epichlorohydrin | | | |
| and Bisphenol A | | | |
| Alkyl Glycidal Ether | 0686609-97-2 | 7-25 | 18 |
| Perox Violet 3B | | 0-0.0002 | 0 |
| Reactor Portion | | | |
| Aromatic Alcohol | 68155-17-9 | 15-35 | 30 |
| Benzoic Acid, | 69-72-7 | 3-10 | 7 |
| 2 Hydroxy | | | |
| (Salicylic Acid) | | | |
| Cycloaliphatic | 2855-13-2 | 35-65 | 51 |
| Diamine | | | |
| Phenol-Nonyl | 108-9-2 | 4-15 | 11 |
| Polymer of | 020585-99-8 | 0.5-2 | 1 |
| Epichlorohydrin | | | |
| and Bisphenol A | | | |
| Trimethyl- | 25620-58-0 | 0-5 | 0 |
| hexaminediamine | | | |
| Perox Violet 3B | | 0-0.0002 | 0.0001 |

The constituents of the preferred base are mixed for about 30 minutes at room temperature (about 55° F. to about 85° F.) with a low-speed agitator. Aromatic alcohol and/or phenol-nonyl may be substituted for up to 5% of the alkyl glycidal ether of the base, provided the alkyl glycidal ether preferably remains at or above approximately 13%.

The constituents of the reactor portion are also mixed together. In the reactor, the cycloaliphatic diamine is the main hardener and provides a blush free and non-sticky hardened resin which has no exudations. The benzoic acid, 2 hydroxy (salicylic acid) and the polymer of epichlorohydrin and bisphenol A function as accelerators. The trimethylhexaminediamine is an optional constituent. The Perox Violet 3B is an optional clearing agent, available in powder form from Pylam Products Company, Inc. of Tempe, Ariz., USA, which provides the resin with a desirable clear quality which can be otherwise difficult to obtain with a resin of the type described above. The Perox Violet 3B may be added to either of the base or the reactor.

The resin material of the present invention is preferably made by mixing two parts of the base portion with one part of the reactor portion for approximately 2 minutes, ideally at 72° F. The mixture is then poured into a mold for curing. Only as much material that is needed to fill each mold should be made up, as the material sets very quickly. The mixture remains pourable for about 10 minutes and is generally unworkable after 15 minutes in the mixing vessel. A 0.5 inch thick slab of material poured into a tile mold is tack-free in about 4 hours and full cure is achieved in about 7 days.

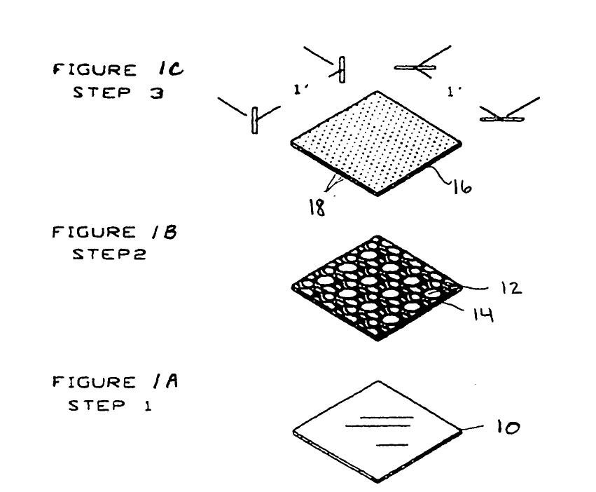

In one exemplar embodiment, one foot square decorative tiles of the present invention were made, as follows. In step 1, shown in FIG. 1A, twelve ounces of the present material was made up and poured into a cavity of a tile mold to fill the mold approximately halfway, making sure all trapped air escaped out of the mixture. This first layer 10 of the material was partially cured a minimum of 6 hours and preferably a maximum of 24 hours (after which time the tile would need to be sanded first) before proceeding to step 2. Decorative elements, as described more particularly in step 2, may optionally be included in this layer.

In step 2, shown in FIG. 1B, the desired decorative elements, e.g., stones 12, pebbles, clay, rock, etc., are preferably arranged on top of the partially cured first layer 10 of material. Sixteen ounces of the present material was then made up and gently poured over the decorative elements 12, to form a second layer 14 of material, preferably being careful not to disturb the pattern of the decorative elements. The tile was further cured, preferably a minimum of 6 hours and preferably a maximum of 24 hours before proceeding to step 3.

In optional step 3, shown in FIG. 1C, twelve ounces of the material was made up and poured over the second layer as a third layer 16. Additional decorative elements 18 (sand, gravel, dye, pigment, materials, clay, powder, etc.) can be added onto the third layer or mixed into the third layer prior to pouring. Dividers or guides may be used to create a desired pattern.

These steps may be repeated as many times as desired, until the mixture is preferably even with the top of the mold and preferably with care so as not to overfill the mold.

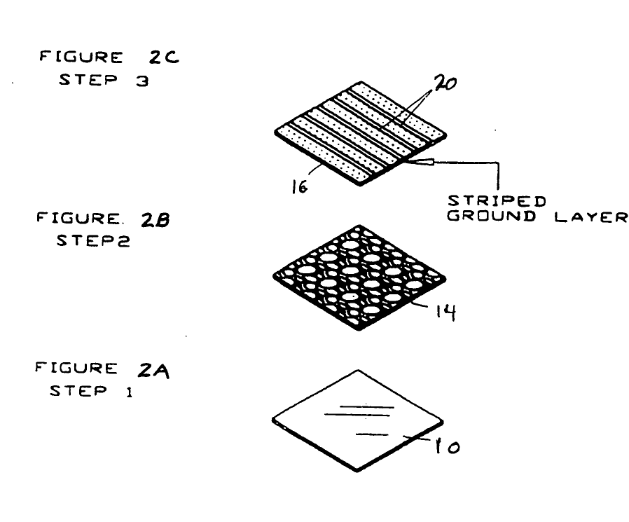

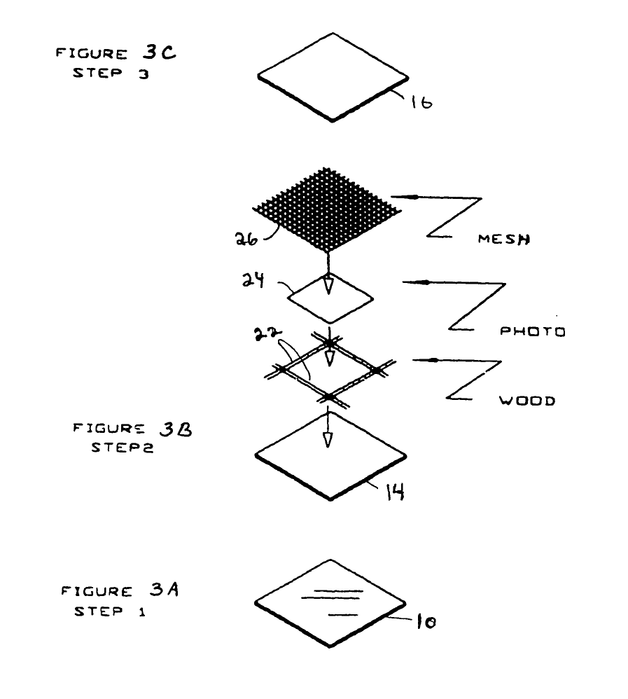

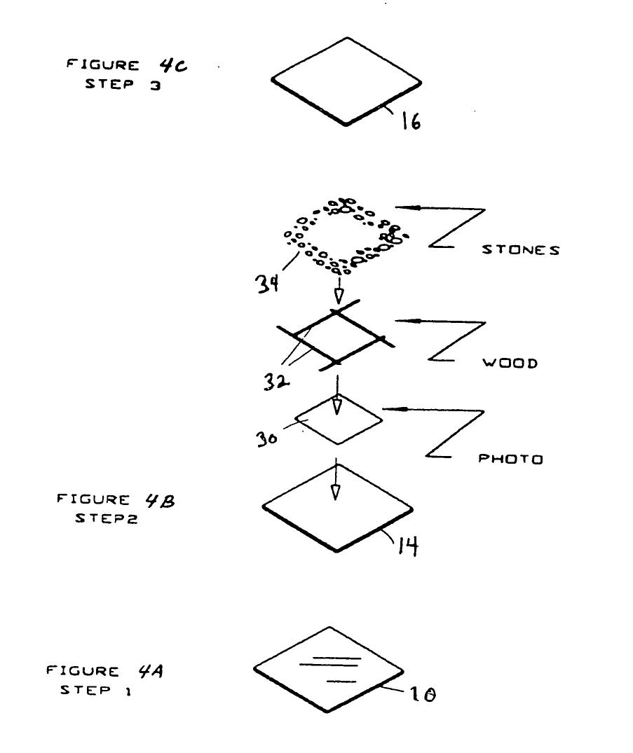

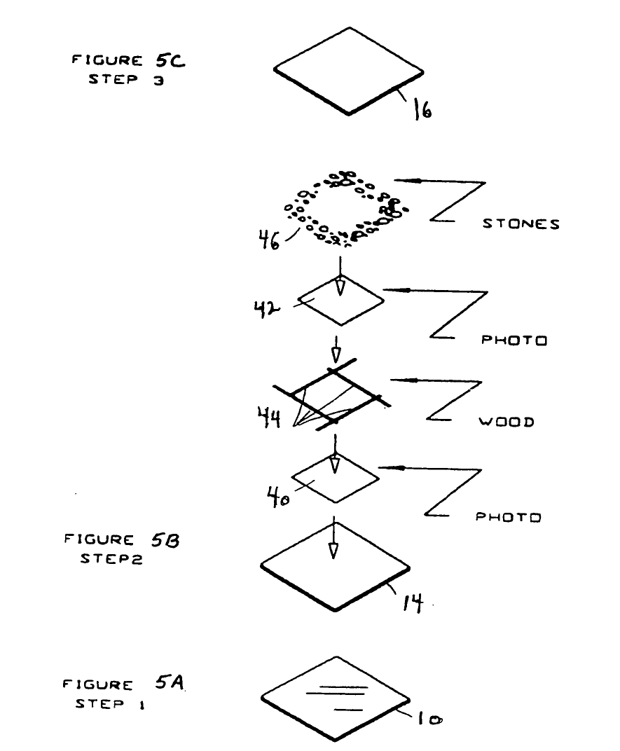

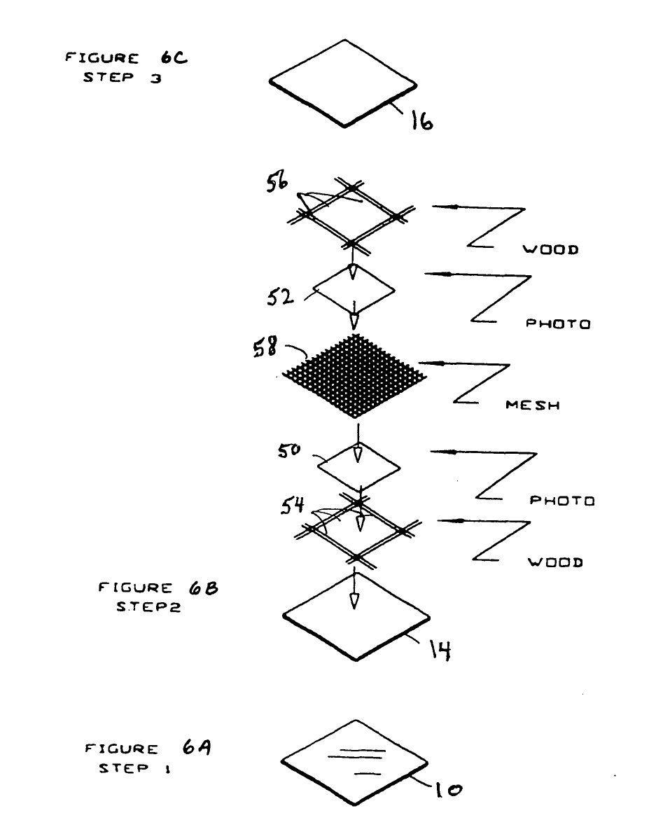

In a second embodiment, shown in FIGS. 2A-C, dividers or guides (not shown) are used in step 3 to create tiles having a desired striped pattern at 20 with the decorative elements. In a third embodiment, shown in FIGS. 3A-C, the decorative elements used in step 2 (FIG. 3B) are wood strips 22, a photograph 24, and mesh 26. In a fourth embodiment, shown in FIGS. 4A-C, the decorative elements used in step 2 (FIG. 4B) are a photograph 30, wood strips 32, and stones 34 arranged in a pattern. In a fifth embodiment, shown in FIGS. 5A-C, the decorative elements used in step 2 are two photographs 40, 42, wood strips 44, and stones 46 arranged in a pattern. In a sixth embodiment, shown in FIGS. 6A-C, the decorative elements used in step 2 are two photographs 50, 52, two sets of wood strips 54, 56, and mesh 58.

Additional decorative elements may also be used, including paint, paint chips and/or pigments, paper-clips, beads, marbles, glass, mulch, glow-in-the-dark materials, and liquids. Further, the decorate element may include flowers, shells, memorabilia, shoes, clothing, dolls, figurative objects, or portions of any of the preceding.

The present invention comprises decorative and functional composite materials in the form of tiles, indoor and outdoor furniture, including beds, benches, tables, tabletops, desks, chairs, and seats and chairbacks; surfaces for work, storage, display, dividing space or standing, including bar tops, countertops, shelves, steps, walls and the like, ceilings, partition walls, dividing screens, wainscoting, baseboards, moldings, windowsills, window frames, window panels, doors, door frames, door jambs; light boxes; trays, letter openers, vases, dishes, serving platters, coasters, utensil handles, planters, lamps and other lighting fixtures, clocks, picture frames, storage devices such as shoe stands, and other utilitarian and decorative structure and items. Furthermore, purely aesthetically functional items such as sculpture forms, mosaics, and other art forms can be created with the composite material.

In each of the items made from the composite material, the composite material comprise a combination of elements embedded and/or encapsulated in an epoxy resin mixture that preferably allows the embedded and/or encapsulated elements to appear as if they are suspended or floating in space.

Items made with the materials of the present invention are thus highly decorative, are extremely durable, and may easily be made according to custom specifications. In addition, the finished tiles are solvent-free. They are waterproof; experience no shrinkage, contraction, or expansion; and are highly resistant to physical or chemical degradation. Specifically, they are resistant to mild mineral acids, alkalis, detergents, solvents, skydrol, hydraulic fluids, lubricating oils, salts, and the like.

The materials provide superior flexibility of design element selection. They are easily installed using adhesives and can easily be cleaned with either a dry or damp mop or cloth, preferably with a biodegradable cleaner. Items, particularly tiles and other planar items, made from the materials may easily be refaced and refinished by lightly sanding and filling with epoxy.

It will now be apparent to those skilled in the art that other embodiments, improvements, details and uses can be made consistent with the letter and spirit of the foregoing disclosure and within the scope of this patent, which is limited only by the following claims, construed in accordance with the patent law, including the doctrine of equivalents.

What is claimed is:

1. A composite material, comprising:
a) an epoxy resin formed from
a base portion comprising (i) a polymer of epichlorohydrin and bisphenol A and (ii) alkyl glycidal ether, and
a reactor portion comprising (i) aromatic alcohol, (ii) benzoic acid, 2 hydroxy, (iii) cycloaliphatic diamine, (iv) phenol-nonyl, and (v) polymer of epichlorohydrin and bisphenol A,
said base portion and said reactor portion provided in a two to one ratio; and
b) decorative elements dispersed within said resin,
wherein said resin is sufficiently transparent such that said decorate elements dispersed within said resin are visible.

2. A composite material according to claim 1, wherein:
said base portion comprises,
(i) 75-93 wt % polymer of epichlorohydrin and bisphenol A, and
(ii) 7-25 wt % alkyl glycidal ether, and
said reactor portion comprises,
(i) 15-35 wt % aromatic alcohol,
(ii) 3-10 wt % benzoic acid, 2 hydroxy,
(iii) 35-65 wt % cycloaliphatic diamine,
(iv) 4-15 wt % phenol-nonyl, and
(v) 0.5-2 wt % polymer of epichlorohydrin and bisphenol A.

3. A composite material according to claim 2, further comprising: Perox Violet 3B.

4. A composite material according to claim 2, wherein:
said decorative element includes at least one of stones, pebbles, clay, rock, sand, gravel, dye, pigment, clay, wood, powder, paints, paint chips, pigment, beads, marbles, glass, glow-in-the dark materials, mulch, liquids, photographs, mesh, and figurative objects.

5. A composite material according to claim 1, wherein:
said decorative element includes at least one of stones, pebbles, clay, rock, sand, gravel, dye, pigment, clay, wood, powder, paints, paint chips, pigment, beads, marbles, glass, glow-in-the dark materials, mulch, liquids, photographs, mesh, and figurative objects.

6. A composite material according to claim 1, wherein:
said epoxy resin comprises at least a surface layer and an under layer, wherein said decorative element is absent from said surface layer.

7. A composite material according to claim 1, wherein:
said epoxy resin comprises at least two layers, and said decorative element is different in each of said at least two layers.

8. A composite material according to claim 1, wherein:
said material is waterproof and highly resistant to physical or chemical degradation.

9. A composite material according to claim 1, wherein:
said material experiences no shrinkage, contraction, or expansion over time.

10. A composite material according to claim 1, wherein:
said material is resistant to mild mineral acids, alkalis, detergents, solvents, skydrol, hydraulic fluids, lubricating oils, and salts.

11. An article, comprising:
a material comprising an epoxy resin formed from a base portion comprising (i) a polymer of epichlorohydrin and bisphenol A and (ii) alkyl glycidal ether, and a reactor portion comprising (i) aromatic alcohol, (ii) benzoic acid, 2 hydroxy, (iii) cycloaliphatic diamine, (iv) phenol-nonyl, (v) polymer of epichlorohydrin and bisphenol A, said base portion and said reactor portion provided in a two to one ratio, and decorative elements dispersed within said resin,
said resin being sufficiently transparent such that said decorate elements dispersed within said resin are visible,
wherein said article comprising the material is one of,
i) furniture,
ii) a surface for work, storage, display, or dividing space;
iii) kitchenware;
iv) a tray,
v) a letter opener,
vi) a vase,
vii) a planter,
vii) a lighting fixture,
viii) a clock,
ix) a picture frame,
x) a coaster, and
xi) a storage device.

12. An article according to claim 11, wherein:
said material further comprises Perox Violet 3B.

13. An article according to claim 11, wherein:
said epoxy resin comprises at least a surface layer and an under layer, wherein said decorative element is absent from said surface layer.

14. An article according to claim 11, wherein:
said epoxy resin comprises at least two layers, and said decorative element is different in each of said at least two layers.

15. A tile, comprising:
a cured epoxy resin comprised of a base portion of (i) a polymer of epichlorohydrin and bisphenol A and (ii) all,yl glycidal ether, and a reactor portion of (i) aromatic alcohol, (ii) benzoic acid, 2 hydroxy, (iii) cycloaliphatic diamine, (iv) phenol-nonyl, and (v) polymer of epichlorohydrin and bisphenol A, said base portion and said reactor portion provided in a two to one ratio, said resin molded in a form so as to have an upper generally planar surface; and b) decorative elements dispersed within said resin,
wherein said resin is sufficiently transparent such that said decorate elements dispersed within said resin are visible.

16. A tile according to claim 15, wherein:
said tile is clear.

17. A tile according to claim 16, wherein:
said resin includes Perox Violet 3B.

18. A tile according to claim 15, wherein:
said surface area does not exceed approximately 144 inches square, and said tile has a thickness not exceeding approximately 0.5 inch.

19. A method of manufacturing a composite material, comprising:
a) first pouring a mixture of a base portion and a reactor portion of an epoxy resin into a mold to form a first layer of the resin;
b) allowing the first layer to at least partially cure;
c) adding a plurality of decorative elements onto the at least partially cured first layer, wherein the decorative elements includes at least one of stones, pebbles, clay, rock, sand, gravel, dye, pigment, clay, wood, powder, paints, paint chips, pigment, beads, marbles, glass, glow-in-the dark materials, mulch, liquids, photographs, mesh, and figurative objects, and wherein no discrete decorative element covers the entirety of the first layer;
d) second pouring a mixture of the base portion and the reactor portion of the epoxy resin into the mold to form a second layer of the resin over the first layer; and
e) allowing the second layer to cure.

20. A method according to claim 19, wherein:
said allowing the first layer to at least partially cure includes curing for preferably six to twenty four hours.

21. A method according to claim 19, further comprising:
providing decorative elements into the first layer.

22. A method according to claim 19, further comprising:
after the second layer is partially cured, third pouring a mixture of the base portion and the reactor portion of the epoxy resin into the mold to form a third layer of the resin over the second layer.

23. A method according to claim 22, further comprising:
providing decorative elements in the third layer.

24. A method according to claim 19, further comprising:
prior to adding the plurality of decorative elements onto the at least partially cured first layer, sanding the first layer.

25. A method according to claim 19, wherein:
the reactor portion comprises,
(i) aromatic alcohol,
(ii) benzoic acid, 2 hydroxy,
(iii) cycloaliphatic diamine,
(iv) phenol-nonyl,
(v) polymer of epichlorohydrin and bisphenol A.

26. A method according to claim 25, wherein:
the reactor portion comprises,
(i) 15-35 wt % aromatic alcohol,
(ii) 3-10 wt % benzoic acid, 2 hydroxy,
(iii) 35-65 wt % cycloaliphatic diamine,
(iv) 4-15 wt % phenol-nonyl,
(v) 1-2 wt % polymer of epichlorohydrin and bisphenol A.

27. A method of manufacturing a composite material, comprising:
a) first pouring a mixture of a base portion and a reactor portion of an epoxy resin into a mold to form a first layer of the resin;
b) first providing a plurality of decorative elements into the first layer;
c) at least partially curing the first layer;
d) second pouring a mixture of the base portion and the reactor portion of the epoxy resin into the mold to form a second layer of the resin over the first layer; and
e) allowing the second layer to cure.

28. A method according to claim 27, wherein:
said providing a plurality of decorative elements includes one of,
i) mixing the decorative elements into the mixture prior to said pouring, and
ii) adding the decorative elements to the layer after said pouring.

29. A method according to claim 27, further comprising:
removing the cured resin from the mold.

30. A method according to claim 27, wherein:
the mixture includes a reactor portion comprising,
(i) 15-35 wt % aromatic alcohol,
(ii) 3-10 wt % benzoic acid, 2 hydroxy,
(iii) 35-65 wt % cycloahphatic diamine,
(iv) 4-15 wt % phenol-nonyl,
(v) 1-2 wt % polymer of epichlorohydrin and bisphenol A,
wherein the base portion and reactor portion are provided in a two to one ratio.

31. A method according to claim 27, further comprising:
second providing a decorative element onto the first layer after at least partially curing the first layer.

32. A method according to claim 19, further comprising:
removing the cured resin from the mold.

33. An epoxy resin composite material, comprising:
a) a first layer of an epoxy resin molded in a form so as to have an upper generally planar front surface with a length and height;
b) a plurality of decorative elements of a first size dispersed within said first layer resin, each of said decorative elements having a length and height substantially smaller than said first layer;
c) a second layer of an epoxy resin coupled to said first layer and forming a back surface of said material; and
d) a plurality of decorative elements of a second size dispersed within said second layer resin, said second size being smaller than said first size,
wherein said first layer is sufficiently transparent such that said decorative elements in said second layer are visible therethrough.

34. An epoxy resin composite material according to claim 33, wherein:
said decorative elements of said second size are even dispersed throughout said second layer.

35. An epoxy resin composite material according to claim 33, wherein:
an intervening epoxy resin layer is provided between said first and second layers.

36. An epoxy resin composite material, comprising:
a) a first layer of an epoxy resin molded in a form so as to have an upper generally planar front surface with a length and height;
b) a plurality of first decorative elements of a first size dispersed within said first layer resin, each of said decorative elements having a length and height substantially smaller than said first layer;
c) a second layer of an epoxy resin coupled to said first layer and forming a back surface of said material; and
d) a second decorative element mixed within said second layer resin,
wherein said first layer is sufficiently transparent such that said decorative element in said second layer is visible therethrough.

37. An epoxy resin composite material according to claim 36, wherein:
said second decorative element is evenly dispersed within said second layer.

38. An epoxy resin composite material according to claim 36, wherein:
an intervening epoxy resin layer is provided between said first and second layers.

39. A method of manufacturing a composite material, comprising:
a) first pouring a mixture of a base portion and a reactor portion of an epoxy resin into a mold to form a first layer of the resin;
b) allowing the first layer to at least partially cure;
c) adding a decorative element onto the at least partially cured first layer, wherein the decorative element includes at least on of the stones, pebbles, clay, rock, sand, gravel, dye, pigment, clay, wood, powder, paints, paint chips, pigment, beads, marbles, glass, glow-in-the dark material, mulch, liquids, photographs, mesh, and figurative objects;
d) second pouring a mixture of the base portion and the reactor portion of the epoxy resin onto the mold to form a second layer of the resin over the first layer;
e) allowing the second layer to cure; and
f) removing the cured resin form the mold.
